(19) United States
(12) Patent Application Publication
(10) Pub. No.: US 2019/0047120 A1
(43) Pub. Date: Feb. 14, 2019

(54) GAS TURBINE ENGINE

(71) Applicant: ROLLS-ROYCE plc, London (GB)

(72) Inventors: Robert J. SMITH, Derby (GB); Daniel CLARK, Derby (GB)

(73) Assignee: ROLLS-ROYCE plc, London (GB)

(21) Appl. No.: 16/050,169

(22) Filed: Jul. 31, 2018

(30) Foreign Application Priority Data
Aug. 3, 2017 (GB) 1712478.5

(51) Int. Cl. B24C 11/00; F01D 5/12; B24C 1/04; B24C 1/00; C09K 3/14

(52) U.S. Cl. CPC B24C 11/00; F01D 5/12; B24C 1/045; F05D 2240/30; C09K 3/1409; F05D 2220/323; F05D 2230/10; B24C 1/003

(57) ABSTRACT

A method of manufacturing a part comprises providing a component for cutting and directing a water jet at the component so as to cut the component. The water jet comprises water and abrasive particles that are crystalline solids formed from organic acid or calcium oxalate.

### CROSS-REFERENCE TO RELATED APPLICATIONS

This specification is based upon and claims the benefit of priority from UK Patent Application Number 1712478.5 filed on 3 Aug. 2017, the entire contents of which are incorporated herein by reference.

### BACKGROUND

### Technical Field

The present disclosure concerns a method of manufacture and/or a method of water jet cutting.

### Description of the Related Art

Gas turbine engines are typically employed to power aircraft. Typically a gas turbine engine will comprise an axial fan driven by an engine core. The engine core is generally made up of one or more turbines which drive respective compressors via coaxial shafts. The fan is usually driven off an additional lower pressure turbine in the engine core.

The fan includes a plurality of blades arranged around a hub. The blades may be metallic or composite blades. Composite blades generally include a body made from a carbon reinforced plastic matrix which may be reinforced in various ways. A metallic leading edge, and often a metallic trailing edge is provided on the body.

The metallic leading edge can be manufactured in a number of different ways, and in some examples the metallic leading edge needs to be cut during the manufacturing process. This cutting can be done using water jet cutting. Water on its own is not sufficiently abrasive to cut the metal, so abrasive garnet particles are added to the water. However, the garnet can become embedded in the metal work contaminating the surface of the cut component. Garnet is chemically inert, so it is not readily removed using chemical processes and as such mechanical processes need to be employed to remove the embedded particles. Removal of the garnet particles from the surface of the component adds cost and time to the manufacturing process.

### SUMMARY

According to an aspect there is provided a method of manufacturing a part, the method comprising providing a component for cutting and directing a water jet at the component so as to cut the component. The water jet comprises water and abrasive particles that are crystalline solids formed from organic acid or calcium oxalate. The crystalline solid may be a heterocyclic compound. The crystalline solids may be formed from a diprotic acid. The crystalline solid may be formed from uric acid. The crystalline solid may comprise uric acid (C₅H₄N₄O₃). Alternatively, the crystalline solids may be formed from citric acid, malic acid, tartaric acid, folic acid, or hydroxyapatite.

The crystalline solid may comprise ammonium acid urate. The crystalline solids comprise one or more metallic ions. For example, the crystalline solids may comprise calcium, magnesium, sodium, lithium or potassium.

The crystalline solids may have an average diameter equal to or between 30 microns and 100 microns, e.g. approximately 50 microns±manufacturing tolerances, i.e. substantially 50 microns.

The crystalline solids may each be surrounded by a second substance that is solid in the water jet and melts at atmospheric temperature and pressure.

The second substance may be ice. Ice refers to frozen water. The water may comprise H₂O and impurities. The water may consist essentially of H₂O. In alternative examples the second substance may be an alternative frozen solution or liquid.

After the component has been cut by the water jet, the method may comprise rinsing the component with a liquid at a temperature equal to or between 30° C. and 100° C. The liquid may be water. The water may comprise H₂O and impurities/additives. The water may consist essentially of H₂O.

The part may be a fan blade for a gas turbine engine, e.g. the cut component may form a metal leading edge or trailing edge of a fan blade.

According to an aspect there is provided a method of water jet cutting a component, the method comprising providing a component for cutting and directing a water jet at the component so as to cut the component. The water jet may comprise water and abrasive particles that are crystalline solids formed from organic acid or calcium oxalate

The method may comprise one or more features of the previous aspect.

According to an aspect there is provided a method of manufacturing a part, the method comprising providing a component for cutting and directing a water jet at the component so as to cut the component. The water jet may comprise water and abrasive particles that are crystalline solids comprising calcium, oxalate, uric acid, urea or derivatives thereof, or hydroxyapatite.

The crystalline solid may comprise calcium oxalate, uric acid, ammonium acid urate, calcium oxide, hetrocyclic urea, or hydroxycarbamide.

The method may comprise one or more features of the method of the previous aspect.

The method of any of the described aspects may comprise filtering a solution formed after cutting so as to separate metallic particles from the solution. The method of any of the described aspects may further comprise recycling the liquid for use in forming crystalline solids.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 is a sectional side view of a gas turbine engine;

FIG. 2 is a schematic of a water jet cutting arrangement and component;

FIG. 3 illustrates a jet of water with abrasive particles from the cutting arrangement of FIG. 2;

FIG. 4 illustrates examples of heterocyclic compound crystals;

FIG. 5 is a schematic of equipment used to grow abrasive particles; and

FIG. 6 is a schematic of a head of the cutting arrangement of FIG. 2.

### DETAILED DESCRIPTION

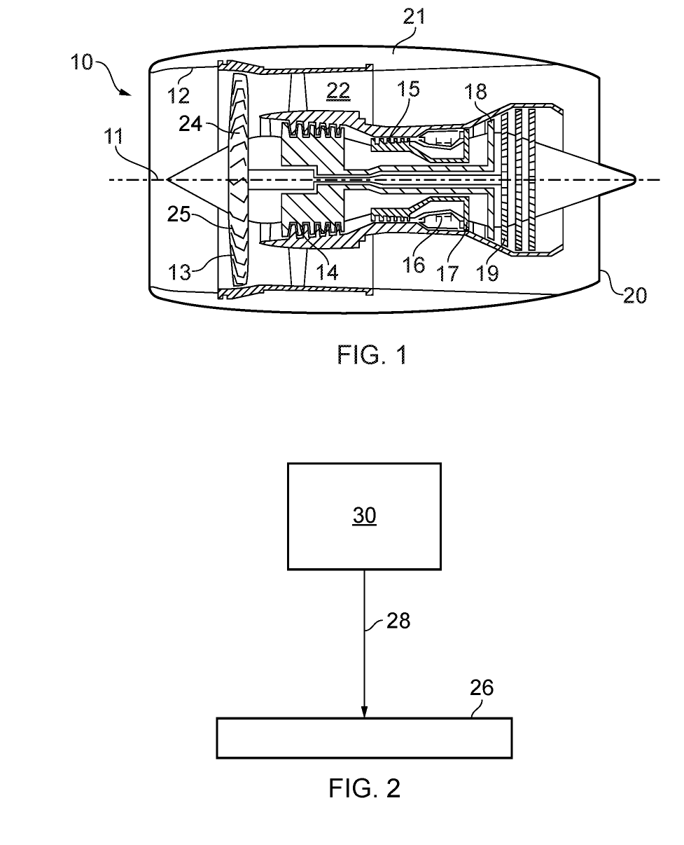

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

The fan 13 includes a plurality of fan blades 24 arranged around a hub. In the present example, the fan blades are composite fan blades and include a metallic leading edge 25. The metallic leading edge is made from metal and is at least partially cut to size using water jet cutting.

The method of water jet cutting will now be described in more detail. Referring to FIG. 2, to cut a component 26 a water jet 28 is directed at the component. The water jet is delivered from cutting equipment 30.

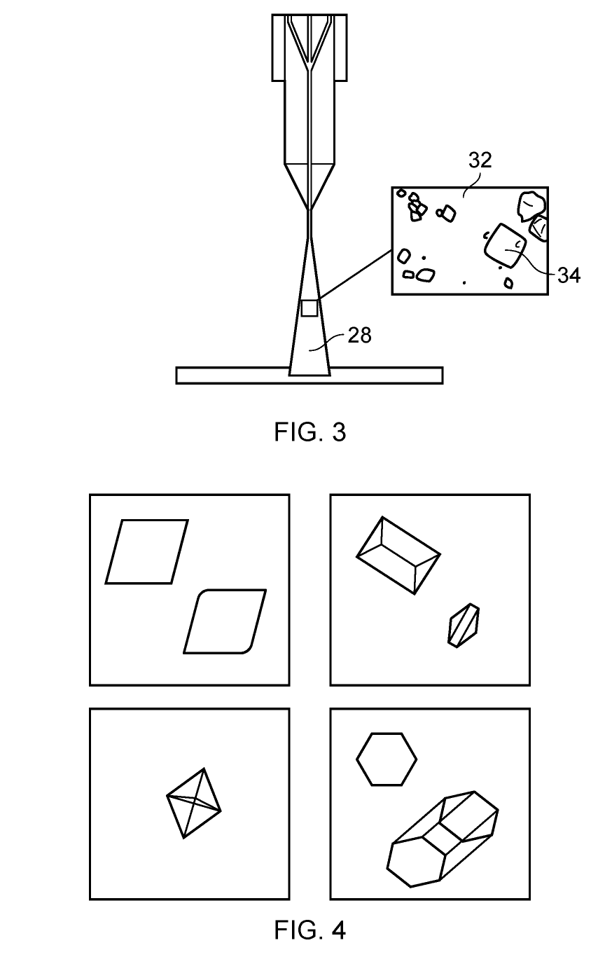

Referring to FIG. 3, the water jet 28 comprises a stream of high pressure water 32 and crystalline solids 34. The crystalline solids are abrasive to improve the cutting action of the water jet. The crystalline solids are selected such that they do not react with the component to be cut. The solubility of the crystalline solids is such that they do not dissolve in the water jet, but can be later rinsed from the surface of the component.

The crystalline solids are ideally angular in shape. The variation in size of the crystals is also preferably limited. For example the diameter of one crystal at a minimum and maximum width may be 20 microns, and of another it may be 40 microns at a minimum width and 90 microns at a maximum width. Example shapes of crystals are shown in FIG. 4.

In the present example, the crystalline solids are uric acid crystals.

The crystals can be manufactured using known manufacturing techniques. For example, a uric acid composition may be freeze dried at high pressure to form crystals. The freeze dried composition may then be blasted with cold liquid or glass to form a plurality of isolated crystals.

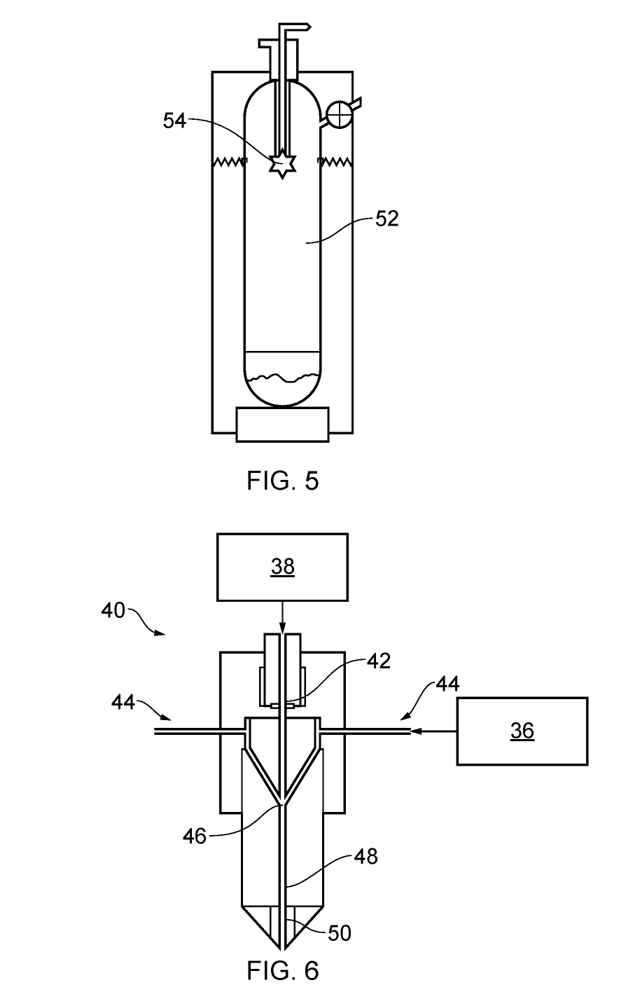

An alternative method of manufacture is illustrated in FIG. 5. This method may be referred to as sublimation and includes heating material to be crystallised under reduced pressure or vacuum until it vaporizes where it then deposits on a cool area of the vessel. As the material is deposited on the cool surface, it converts into a crystalline form. A nuclei seed can be placed at the tip of the cooled finger prior to starting sublimation allowing the crystal to form around it. For example, the material to be crystallised may be heated under pressure in the pressure vessel 52. A nuclei seed 54 may be provided around which the crystal can form.

Referring now to FIG. 6, the cutting equipment (illustrated at 30 in FIG. 2) includes a supply 36 of uric acid crystals and a supply 38 of water. A head 40 is provided. Water from the water supply can enter the head via a water inlet 42. Uric acid crystals can enter the head via a crystalline solid inlet 44. Downstream of the water inlet and the crystalline solid inlet there is provided a mixing cavity 46, where the crystalline solid mixes with the water. A focus tube 48 is provided downstream of the mixing cavity. Downstream of the focus tube is provided a control orifice 50 which controls the flow of water from the head.

During operation, high pressure water is supplied from the water supply 38 to the water inlet 42. Crystalline solids, in this example uric acid crystals, are provided to the head via the crystalline solid inlet 44. The crystals may be fed to the inlet 44 either using a gravity feed or a mechanical feed. The flow rate of the water and the flow rate of the crystals can be selected to achieve the desired mixture of water and crystals for optimised cutting. The crystals and water flow to the mixing cavity 46 where the crystals are introduced to the flow of high pressure water. The crystals and high pressure water then flow to the focussing tube 48. The diameter of the focussing tube can be selected for the desired cutting precision. The high pressure water and crystals exit the head via the control orifice 50 which is dimensioned to further control the output of the water and crystals mixture for a given cutting precision, for example high speed cutting, high precision edge cutting, or super fine precision edge cutting.

In the present example, the crystalline solids are not recirculated and are removed by filtration from the mixture of water and crystals that has been used to cut the component using a filtration process such as a cyclone or electrostatically assisted filtration. However, in alternative examples, the solution of water and crystals may be recirculated. In such cases a monitoring sensor may be provided to measure the concentration of crystals in the water, and the amount of crystals added to the solution can be adjusted accordingly. In a further alternative, the solution of crystalline solids, metal, water and dissolved solids can be collected after cutting and recycled, for example to form new crystalline solids.

Once the component has been cut, the surface of the component can be washed with warm water, for example water at or equal to 30° C. and 100° C. The composition of the uric acid crystals means that they can be dissolved from the surface of the component with warm water, such that the surface of the component is not contaminated. In some examples, the recycling of the solution mentioned previously may be performed after rinsing.

In alternative examples, the crystalline solid may have a second substance, e.g. ice, formed around it. The process of cutting the component can be substantially the same as that described. The ice can be formed around the crystal either before it is supplied to the head of the cutting equipment or whilst in the cutting equipment, e.g. proximal to the mixing cavity. In both cases, liquid nitrogen can be used to form the ice around the crystalline solid. The advantage of forming ice around the crystalline solid is that it is solid during the cutting process, so can improve the cutting process, but ice melts at atmospheric temperature and pressure so the crystalline solids are less likely to embed in the surface of the cut component.

The described example uses uric acid crystals, but in alternative examples other crystalline solids may be used. For example crystals of other organic acids may be used, for example other diprotic acids, citric acid, malic acid, tartaric acid, or folic acid. In other examples the crystals may comprise calcium, for example calcium oxalate. The crystals may be formed from hydroxyapatite. The crystals may be formed for urea or derivatives thereof, for example hetrocyclic urea, or hydroxycarbamide. In many examples it is desirable for the crystals to be formed from a heterocyclic compound.

In alternative examples, the crystalline solids may comprise metal ions. For example, calcium, magnesium, sodium, lithium, or potassium may be added to the composition of the crystalline solids. The metal ions may be used to supress the crystalline solids solubility in water. The suppression of solubility will be balanced between improved cutting and the ability to dissolve the crystalline solids after cutting. The metal ions and salts of the crystalline solids may be selected so as to optimise the process for a given machine operating conditions (including temperature).

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A method of manufacturing a part, the method comprising:
providing a component for cutting; and
directing a water jet at the component so as to cut the component, the water jet comprising water and abrasive particles that are crystalline solids formed from organic acid or calcium oxalate.

2. The method according to claim 1, wherein the crystalline solid is a heterocyclic compound.

3. The method according to claim 1, wherein the crystalline solids are formed from a diprotic acid.

4. The method according to claim 1, wherein the crystalline solid is formed from uric acid.

5. The method according to claim 4, wherein the crystalline solid comprises ammonium acid urate.

6. The method according to claim 1, wherein the crystalline solids comprise one or more metallic ions.

7. The method according to claim 1, wherein the crystalline solids have an average diameter equal to or between 30 microns and 100 microns.

8. The method according to claim 1, wherein the crystalline solids are each surrounded by a second substance that is solid in the water jet and melts at atmospheric temperature and pressure.

9. The method according to claim 8, wherein the second substance is ice.

10. The method according to claim 1, further comprising, after the component has been cut by the water jet, rinsing the component with a liquid at a temperature equal to or between 30° C. and 100° C.

11. The method according to claim 10, wherein the liquid used to rinse the component is water.

12. The method according to claim 1, wherein the part is a fan blade for a gas turbine engine.

13. A method of water jet cutting a component, the method comprising:
providing a component for cutting; and
directing a water jet at the component so as to cut the component, the water jet comprising water and abrasive particles that are crystalline solids formed from organic acid or calcium oxalate

14. A method of manufacturing a part, the method comprising:
providing a component for cutting; and
directing a water jet at the component so as to cut the component, the water jet comprising water and abrasive particles that are crystalline solids comprising calcium, oxalate, uric acid, urea or derivatives thereof, or hydroxyapatite.
